(19) United States
(12) Patent Application Publication
(10) Pub. No.: US 2011/0055255 A1
(43) Pub. Date: Mar. 3, 2011

(54) METHOD FOR DOWNLOADING A DATA SET TO AN OUTPUT DEVICE

(75) Inventors: Geoffrey H. Shaw, Webster, NY (US); Paul J. van Wichen, Webster, NY (US); Nicholas D. Bartolotti, Honeoye Falls, NY (US); Frederick A. Schempp, III, Webster, NY (US)

(73) Assignee: Pharos Systems International Inc., Rochester, NY (US)

(21) Appl. No.: 12/868,036

(22) Filed: Aug. 25, 2010

Related U.S. Application Data
(60) Provisional application No. 61/275,149, filed on Aug. 26, 2009.
(60) Provisional application No. 61/275,157, filed on Aug. 26, 2009.

(51) Int. Cl. G06F 17/30

(52) U.S. Cl. 707/769; 707/E17.014

(57) ABSTRACT

A method for downloading a data set from a network application to an output device, comprising the steps of initiating the network application; uploading search and discovery parameters to the network application to identify and locate the output device, the parameters being selected from geographical locating information, identifying information, prior access and usage information, and combinations thereof; identifying and locating the output device via an algorithm and a database in the network application; and downloading the data set to the output device. The network application preferably is distinct from the output device. The data set may be, for example, a file, an image, a video recording, an audio recording, other digital format file, or a written document. The output device may be, for example, a printer, document display device, laptop computer, mainframe computer, mobile device, video projector, or any other computerized device.

### RELATIONSHIP TO OTHER APPLICATIONS AND PATENTS

The present application draws priority from two pending U.S. Provisional patent applications, Ser. Nos. 61/275,149 and 61/275,157, both filed Aug. 26, 2009.

### FIELD OF THE INVENTION

The present invention relates to computer-controlled output devices (for example, printers, iPADs, mobile phones, laptop computers, and/or any other computerized type device); more particularly, to means for linking such output devices to data sets stored in network applications; and most particularly, to a method for remotely selecting an output device for downloading of a data set to the output device by searching a plurality of physical and logical location identifiers, output device characteristics, and output access records.

### BACKGROUND OF THE INVENTION

It is well known to download a data set from a originating input device such as a computer to an output device such as a printer. In the older prior art, this is accomplished typically by what is known in the trade as “push” technology, wherein the output device is specified at the input device, and the data set is “pushed” through the system. In more recent prior art, so-called “pull” technology is known, wherein the data set is released from a network application by user request to initiate the “pull” of the data set through the system to the output device.

A first shortcoming of the prior art pull system is that each output device must be equipped with a network application, for example, embedded systems or terminal devices added to the output device. This increases the cost of an output device, as well as requiring hours of installation time for each device. For a facility such as a large business having a very large number of output devices, equipping all devices with network applications is a practical, logistical, and financial challenge. Further, multi-functional device platforms are non-standard across manufacturers and models and the output device systems configurations are static.

A second shortcoming of the prior art pull system is that, because the network application is resident on the output device, an output device must be specified at the time a data set is generated.

What is needed in the art is a dynamic and scalable download system wherein a network application is distinct from any specific output device and thus may serve a large number of output devices connected by private and public networks.

It is a primary object of the present invention to provide a method for downloading a data set to one or more desired output devices by specifying search parameters for each such device to a remote network application wherein the data set is known. The desired output device or devices, therefore, need not be specified at the time that the data set is generated and known in the network application.

### SUMMARY OF THE INVENTION

The present invention is directed to a dynamic and scalable data set download system wherein a network application is distinct from any specific output device and thus may serve a large number of output devices connected by private and public networks. A method for downloading a data set to one or more desired output devices by specifying search and discovery parameters for each such device to a remote or local network application wherein the data set is known comprises the steps of a) initiating the network application via a communication device, such device chosen from, an output device, software residing on an output device, a network peripheral device, or mobile communications device; b) uploading search and discovery parameters to the network application to identify and locate the output device, the search and discovery parameters being selected from the group consisting of geographical locating information, identifying information, prior access and usage information, and combinations thereof; c) identifying and locating the output device via an algorithm and a database or alternate data source in the network application, or from uploaded search and discovery parameters; d) downloading the data set to the selected output device, and e) embedding GPS or other geographic locating technology for the purpose of dynamically identifying the current location of the output device.

### BRIEF DESCRIPTION OF THE DRAWING

The present invention will now be described, by way of example, with reference to the accompanying drawing, in which:

FIG. 1 is an algorithm for a network application, also referred to herein as a dynamic device locator, in accordance with the present invention.

### DETAILED DESCRIPTION OF THE EMBODIMENTS

A system in accordance with the present invention for downloading a data set from a network application wherein the data set is stored within the network application comprises, at least one output device, a network application distinct from the output device and including an algorithm and data base or alternate data sources responsive to input signals, and a communication device for transmitting the signals. It is an important feature of the present invention that the network application is not resident on any specific output device but rather may be connected to any of a plurality of output devices interconnected on a communication network such as the World Wide Web. Preferably, the network application is resident in the “cloud” on the internet.

A user can initiate a method of detection/discovery of a suitable output device, e.g., a printer. The physical detection (also referred to herein as “geographical locating information”) can be the translation of topographical coordinates, physical mapping, ambient radio frequency noise, video pattern or code, audio pattern or code, or other descriptive terms that determine the unique address of the device. Each device may be identified by other character and feature specifics and grouped or batched as the output device, such as a locator device, a global positioning system, a tag identifier, an electronic receiver, or a search and find application, for instance a map showing recognized features such as a building, a floor, a room, an output device description, and/or the like.

Geographical location information can be captured from any commercially available fixed position technologies system capable of determining a geographic locations, such as embedded GPS, RFID, or similar position fixing technology in or on an output device that broadcasts its position over commercially available signals such IP traffic, Wi-Fi, Bluetooth, 3G, NFC, or cellular, and provides access to a database of that information. Further, such locating technology may be included on an output device at time of manufacture or may be added later, as a peripheral add-on.

For initiating and uploading, a user relies on a communication device, e.g., a cell phone or other mobile device capable of communication. Triangulation of the appropriate output device can be by combining global GPS technology, wireless technology, NFC, ambient radio frequency noise, or other technologies that mathematically determine the physical location via the algorithm in the network application.

As will be obvious from the foregoing, the present invention is capable of downloading a data set to a plurality of output devices, for example, a class lesson to a plurality of laptop computers and personal readers, such as a kindle, nook, or iPad, in a classroom.

Use example: A user approaches an output device, e.g., a printer, initiates a network application from a mobile communication device, e.g., a cell phone or smartphone, or from an application resident on the output device, and selects for printing a data set (document, file, or the like) stored in the network application. The network application automatically “knows” the location/address of the adjacent output device based on GPS coordinates or other geographical locating information sent from the communication device or directly from the output device or from video or audio pattern recognition. Alternatively, the communication device may employ another locating option such as ‘bump’ technology with the output device or ambient noise with no reliance on a known signal type or Near Field Communication (NFC), wherein the communication device picks up a unique output device logical identification that it forwards to the network application which then algorithmically determines from the data set the identity and location of the output device and sends the selected file for printing. The network application derives the probability the device is physically and logically in a specific location with a proprietary algorithm that joins, analyzes, and evaluates the above data and predicts the probability of users using said device, thus providing required validation of the physical presence of an output device for owner's management and control plus additional visual mapping and location information. The system predicts the output device's physical geographic and logical location and identifies all output devices that are exceptions to the expected result, thus allowing managers to resolve discrepancies.

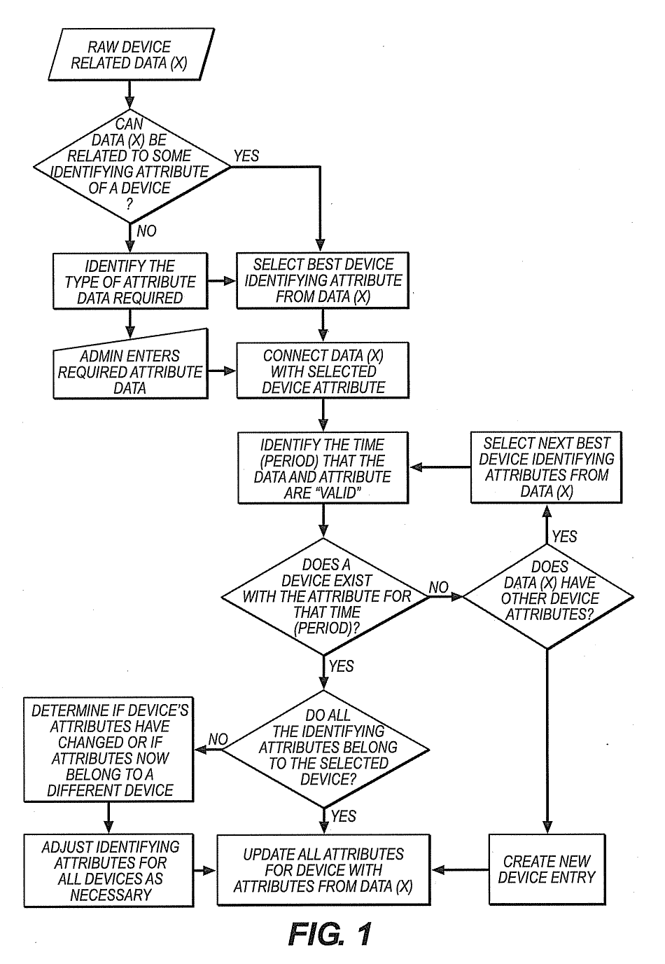

Input to the network application is received and processed to create a new entry for each output device resident in the database of the network application in accordance with the algorithm shown in FIG. 1.

The network application also records and stores in the database the output device's prior usage (document output volumes such as hard copies, printed copies, faxes, scanned documents), and print drivers that enable the usage, and users, as recorded by the device and captured and data based by the system; also the output device's ongoing usage and users, as captured and data based by the system.

In addition to the device usage information, user activity is also collected to build a complete understanding of the device and all of its attributes. These sources are not guaranteed to represent the actual physical device. The information may reflect only an attribute of the device (i.e. its network address). Also, the information is time sensitive (i.e. a device's network address may change each day). The information is stored in the database in its raw form; an automated process subsequently analyses the data to determine what physical devices exist and the attributers of these devices (e.g. who is using what device and how are they using them, what are the capabilities of the device, where is the device located, and the like).

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for downloading a data set to an output device from a network application distinct from any specific output device, comprising the steps of:
a) initiating said network application;
b) uploading search and discovery parameters to said network application to identify and locate said output device, said search and discovery parameters being selected from the group consisting of geographical locating information, device identifying information, prior access and usage information, and combinations thereof;
c) identifying and locating said output device via an algorithm and a database in said network application; and
d) downloading said data set to said output device.

2. A method in accordance with claim 1 wherein said data set is selected from the group consisting of a file, an image, a video recording, an audio recording, a written document, other digital rendered format, and combinations thereof.

3. A method in accordance with claim 1 wherein at least some of said search parameters for said uploading are obtained from said output device.

4. A method in accordance with claim 1 wherein said uploading step is carried out by a communication device apart from said output device, and wherein software for conducting said initiating step is resident in said communication device.

5. A method in accordance with claim 4 wherein said communication device is selected from the group consisting of printer, iPod, mobile device, image display device, computer, projector, contingence of any of the forementioned, and network.

6. A method in accordance with claim 1 wherein said geographical locating information is selected from the group consisting of street address, GPS address, map coordinates, latitude/longitude coordinates, electronic rendered coordinates, wireless coordinates, and combinations thereof.

7. A method in accordance with claim 1 wherein said identifying information is selected from the group consisting of network address, serial number, discovered network configuration, unigue ID or signal, and combinations thereof.

8. A method in accordance with claim 1 wherein said output device further comprises apparatus for broadcasting said search and discovery parameters over commercially available signals.

9. A method in accordance with claim 8 wherein said commercially available signals are selected from the group consisting of IP traffic, Wi-Fi, Bluetooth, 3G, RFID, “bump”, cellular, Near Field Communication, video and audio pattern matching, electronic signal, application identification, and combinations thereof.

10. A method in accordance with claim 1 wherein said network application is capable of receiving and storing information on prior access and usage of said output device.

11. A method in accordance with claim 1 wherein said network application is capable of determining drivers that enable receiving of said data set by said output device, and wherein said downloading step includes transmission of said drivers to said output device.

12. A method in accordance with claim 1 comprising the further step of downloading said data set from said network to at least one other output device.

13. A method in accordance with claim 1 wherein said output device is selected from the group consisting of printer, document display device, laptop computer, mainframe computer, mobile device, projector, and any other computerized device.

14. A method in accordance with claim 1 wherein said downloading step is performed to a plurality of different output devices.

15. A method in accordance with claim 1 further comprising the step of managing data set restriction and control rights which can include, but are not limited to, user access rights, group access rights, output format restrictions, time based rights, copy and distribution rights, and geographic usage restrictions.
